(19) United States
(12) Patent Application Publication
(10) Pub. No.: US 2007/0214646 A1
(43) Pub. Date: Sep. 20, 2007

(54) SHAVER

(76) Inventor: Vojtech Bezdek, Roznov pod Radhostem (CZ)

Correspondence Address: BROOKS KUSHMAN P.C., 1000 TOWN CENTER, TWENTY-SECOND FLOOR, SOUTHFIELD, MI, 48075, US

(21) Appl. No.: 11/532,624

(22) Filed: Sep. 18, 2006

Related U.S. Application Data
(63) Continuation-in-part of application No. PCT/CZ05/00009, filed on Jan. 31, 2005.

(30) Foreign Application Priority Data
Mar. 16, 2004 (CZ) PV 2004-373

(51) Int. Cl. B26B 19/44

(52) U.S. Cl. 30/41

(57) ABSTRACT

Before shaving with shaver with a removable protection cap, a uniform layer of shaving media is spread on the face through cross ribbing and holes. Shaving media flow is the same without using the protection cap therefore the nature of the shaver will be described in shaving. By turning the regulator (3) the screwing (7) pushes down the standard stopper (4) of a spray dispenser with pressurized shaving foam (8). The foam flows through the hollow duct (5) of the cutter block (6) into channels (13) and ends in front of the second cutting edge (2) and then on the face. The first cutting edge (1) together with the shaving media spread on the face before shaving trims the facial hair. At the same time, the second cutting edge (2) and shaving media dispensed on the face trims the rest of the facial hair, and the facial hair is discharged through side holes (10) of the cutter block (6) under shaving foam pressure. The cutter block (6) side holes (10) are covered when the protection cap (9) is put on.

### CROSS-REFERENCE TO RELATED APPLICATIONS

This is a continuation of PCT international application no. PCT/CZ2005/000009, with an international filing date of Jan. 31, 2005, which is incorporated by reference herein, which claims priority to PV 2004-373, filed Mar. 16, 2004.

### BACKGROUND OF THE INVENTION

1. Field of the Invention

The invention relates to one of the basic needs of ordinary personal hygiene for men: shaving facial hair. Shaving usually requires a shaving media (soaps, foams, gels, creams) and an instrument to be used as a shaver. There are many different safety razors, electric razors and cutthroat razors that may be used to shave.

2. Background Art

Shavers or safety razors usually have a razor blade or steel cutting edge, which provides one cutting edge. To achieve higher shaving efficiency, modern shavers may have two or more inline cutting edges. During shaving, the hair is cut off by the first cutting edge then by the second one and finally by the third one. Shaving media is always removed from the face by the first razor-edge. There is a complete absence of shaving media before using the second and third cutting edges during shaving, which is sometimes called “dry shaving”.

Using a shaving media makes shaving easier and also protects the skin. It is supplied to the consumer in different packaging, usually in sprays. According to the directions for use of a pressurized shaving media, a layer should be applied on wet skin by hand.

### SUMMARY OF THE INVENTION

Mutual connection of a shaver and shaving media that both are used in shaving is desirable. The present invention does this by linking together the two essential things required for shaving: shaving media and a shaver. The present invention creates one compact shaving set and improves shaving along all of the cutting edges at the same time.

The shaver has of three main aspects. The first aspect is a removable protection cap with several holes and cross ribbing. The second aspect is a cutter block with cutting edges and a hollow duct to control the flow of the pressurized shaving media and rotary regulator. The final aspect of the shaver is a shaver handle, which has a pressurized shaving media container to spray.

The removable protection cap covers the cutting edges when placed on the shaver. The removable protection cap has holes and cross ribbing which allow for shaving media to be spread in a uniform layer on a wet face before shaving. After spreading the shaving media on the face, the protection cap may be taken off to expose the cutting edges.

The cutter block with cutting edges has a hollow duct. The hollow duct has three channels which lead to the second cutting edge. The cutter block also has a regulator to control the amount of pressurized shaving media dispensed. While shaving, a certain amount of shaving media is dispensed from the shaving media holder through the hollow duct to the channels. The channels allow the shaving media to be dispensed before the second cutting edge cuts hair on the face.

When shaving, the first cutting edge and shaving media already on the face cut some of the facial hair. While this happens, shaving media is being dispensed through the channels onto the face before the second cutting edge cuts the hair. With the shaving media newly dispensed, the second cutting edge trims the rest of the facial hair. The facial hair is discharged through the side holes of the cutter block under pressure of the shaving media. The regulator protects against accidental shaving media discharge by its position or by locking.

The shape of the shaver handle, which includes the shaving media holder, should be ergonomically designed. This allows for a user to hold it as comfortably as if the user where using another type of shaver, such as an electric shaver.

### BRIEF DESCRIPTION OF THE DRAWINGS

FIG. 1 is an enlarged sectional view of a shaver in accordance with the present invention;

FIGS. 2a and 2b is an enlarged partial view of a shaver in accordance with the present invention;

FIGS. 3a and 3b are perspective views of another embodiment of the shaver in accordance with the present invention; and

FIGS. 4a, 4b, and 4c are perspective views of another embodiment of the shaver in accordance with the present invention.

### DETAILED DESCRIPTION OF THE EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

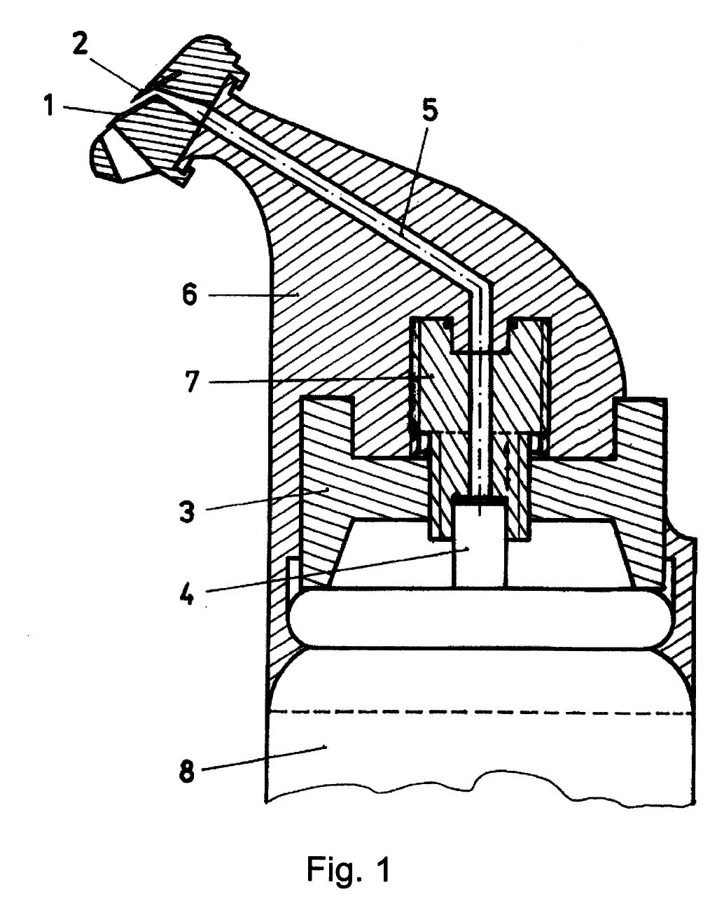

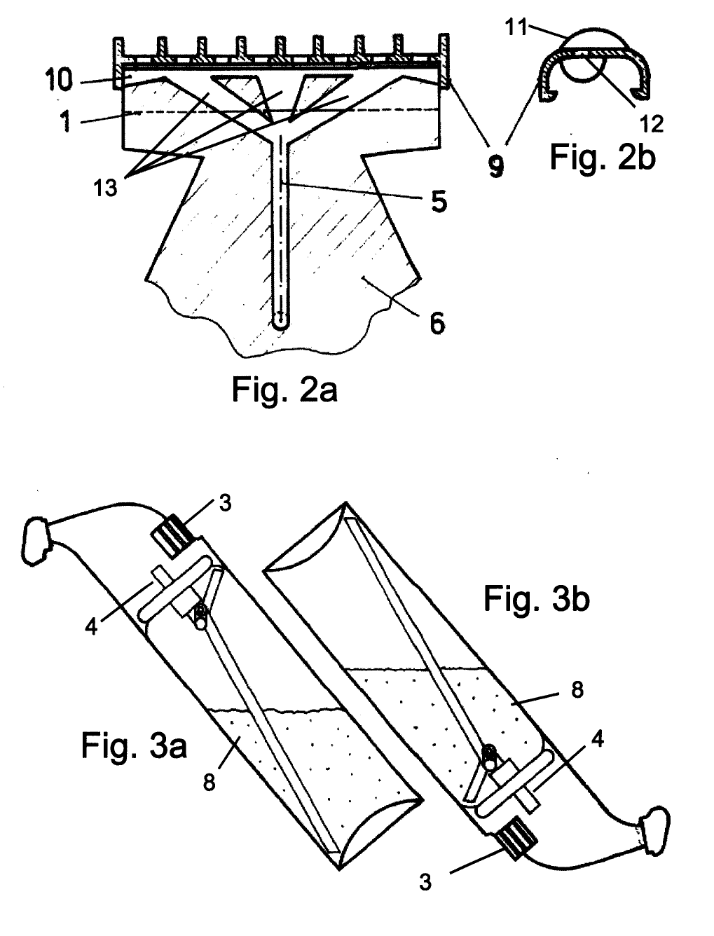

Referring to FIGS. 1, 2a, and 2b, a shaver is shown. When the removable protection cap 9 is on the shaver, shaving media may be dispensed onto the face through the ribs 11 and holes 12. Any suitable substance that may be dispensed and used for shaving is contemplated within the scope of the present invention. Examples of shaving media, which are not meant as a limitation, include: soaps, foams, gels, or creams.

By turning the regulator 3 the screwing 7 pushes down the standard stopper 4 of a spray with pressurized shaving media 8. The media flows through the hollow duct 5 into channels 13 and ends in front of the second cutting edge 2. In the present embodiment, three channels 13 are illustrated. Any suitable amount of channels 13 is contemplated within the scope of the present invention.

Once the shaving media flows through the channels 13, the media flows through holes 12 of the protection cap 9 onto the wet face. The layer of shaving media is uniformly applied to the face by cross ribbing 11 of the protection cap 9.

When the shaver is operated without the removable protection cap 9, the regulator 3 may be turned to engage the screwing 7, which pushes down the stopper 4. This allows the shaving media to flow out of the pressurized shaving container 8. The media flows through the hollow duct 5 into channels 13 and is dispensed before the second cutting edge 2 onto the face.

When in use, the first cutting edge 1 and shaving media spread on the face before shaving trim the facial hair. At the same time, the second cutting edge 2 and the shaving media dispensed through the channels 13 onto the face trims the rest of the facial hair. The cut hair is discharged away through dispensing holes 10 in the side part of the cutter block 6. These dispensing holes 10 are covered when the protection cap 9 is put on.

The protection cap 9 of shaver may be made of elastic transparent plastic, for example. Production technology of the cutter block 6 with two cutting edges may be supplemented with the hollow duct 5 with three channels 13, ending in front of the second cutting edge 2.

The parts of the regulator 3 may be made of plastic and for easier cleaning of cutter block 6 it may be black or grey (Umacryl K1, polystyrene). The regulator 3 and screwing 7 may be linked together with sliding grooving or hexagon.

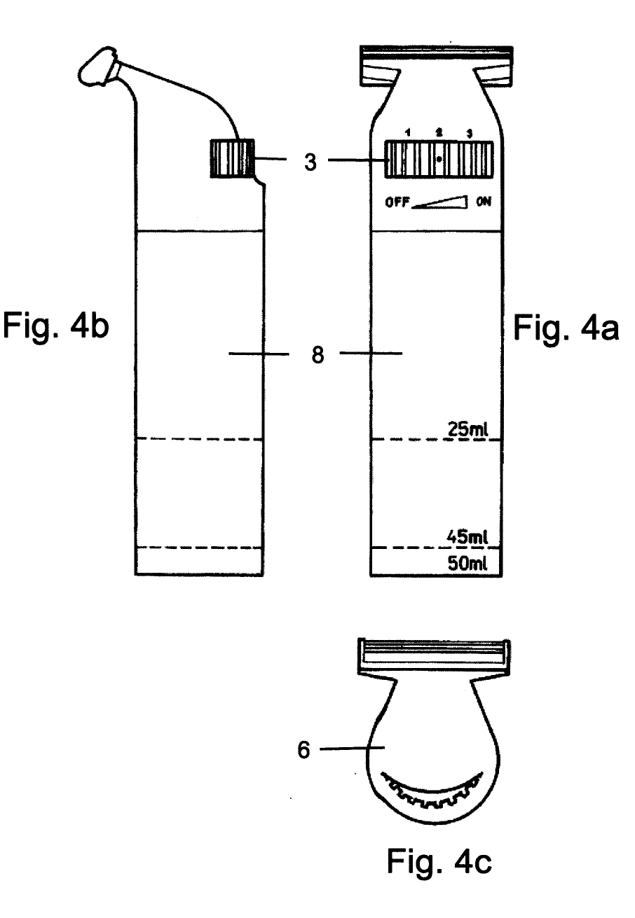

Assembly of regulator 3 in the cutter block 6 of shaver may be from the side of a spray dispenser 8. The regulator 3 may be marked by printing or by moulding. Production technology of a spray dispenser 8 may be supplemented with a two-way valve with automatic changing of the flow when operating position one through three is changed, as illustrated in FIG. 4a. The two-way valve should be integrated with standard stopper 4.

Assembly of the cutter block 6 and spray dispenser 8 should be fixed with defined operating position in positions one through three. Spray dispenser 8 may be marked by printing or by self-adhesive label with the name of a product including directions for use:

“Shake before using. Wash your face with hot water. After placing protection cap on shaver, turn on the regulator and apply the shaving foam uniformly on the face. Turn off regulator, take off the protection cap and turn the regulator to a lower setting than before to decrease the amount of shaving foam to be dispensed. Shave desired area. WARNING: Pressurized container do not expose to temperatures exceeding 50 degrees Celsius. Protect from sunlight. Do not pierce or burn, even after use. Contents is flammable.”

With reference to FIGS. 1, 2a and 4c, shavers with different cutter blocks 6 design may be used. The different cutter blocks 6 may be single use or reusable. One cutter block 6 may have one cutting edge 1 with channels 13 ending in front of the one cutting edge 1. The simple design may make fine hair shaving possible. It may be used without shaving foam spread on a face before shaving.

Another cutter block 6 may be designed for single-use. The two firmly located cutting edges may depreciate to limit the lifetime of the cutter block 6. Yet another cutter block 6 would be a general-purpose cutter block 6, which would allow for worn-out cutting edges to be replaced. Another cutter block 6 may have three or more cutting edges, although this is not optimal because of higher shaving foam consumption.

Referring to FIGS. 3a and 3b, a shaver may be used in an upright position as shown in FIG. 3a or in an inverted position as shown in FIG. 3b. This allows for rotation of the shaver, while still providing shaving media before a cutting edge.

In FIGS. 4a and 4b, another embodiment of the shaver is illustrated. The regulator 3, is shown with numbers one through three on it to control the flow of the shaving media. Also, different sizes of shaving media dispensers 8 may be provided in the amounts listed, or in differing amounts.

In summary, the design of the present invention allows for more comfortable shaving by providing new shaving media directly to the face while shaving. This allows for speedy and practical use.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. Shaver for applying shaving media on a human face especially before shaving, and for shaving stubble, the shaver comprising:
a shaving media dispenser together with a cutter block, the shaving media dispenser forming part of a shaver handle of the shaver, the cutter block including a turning regulator for selectively allowing shaving media to be dispensed from the shaving media dispenser and being provided with side holes for ejecting the shaving media out of the cutter block from the shaving media dispenser during shaving and during applying the shaving media on the face, the side holes being coverable by a removable protective cap, the removable protective cap including cross-ribbing and holes for allowing shaving media from the shaving media dispenser to be distributed on the face prior to shaving.

2. Shaver according to claim 1 wherein the cutting block includes at least two cutting edges, and the side holes is disposed to eject the shaving media between the at least two cutting edges.
